(19) United States
(12) Patent Application Publication
(10) Pub. No.: US 2016/0173492 A1
(43) Pub. Date: Jun. 16, 2016

(54) AUTHENTICATION METHOD USING BIOMETRIC INFORMATION AND ELECTRONIC DEVICE THEREFOR

(71) Applicant: Samsung Electronics Co., Ltd., Gyeonggi-do (KR)

(72) Inventors: Young-Eun HAN, Gyeonggi-do (KR); Ki-Huk LEE, Gyeonggi-do (KR); Moon-Soo KIM, Seoul (KR); Kwang-Sub SON, Gyeonggi-do (KR); Bo-Seul JEON, Gyeonggi-do (KR)

(21) Appl. No.: 14/969,074

(22) Filed: Dec. 15, 2015

(30) Foreign Application Priority Data
Dec. 15, 2014 (KR) 10-2014-0180651

(51) Int. Cl. H04L 29/06; G06Q 20/20

(52) U.S. Cl. CPC H04L 63/0861; H04L 63/102; G06Q 20/20; H04L 63/0853

(57) ABSTRACT

An authentication method using biometric information and an electronic device. An authentication method using biometric information in an electronic device includes: receiving biometric information from an external electronic device. An authentication is performed for the received biometric information by comparing the received biometric information with biometric information stored in the electronic device. An authentication result us transmitted to the external electronic device such that the external electronic device performs a predesignated operation.

### CLAIM OF PRIORITY

This application claims the priority under 35 U.S.C. §119(a) from Korean Application Serial No. 10-2014-0180651, which was filed in the Korean Intellectual Property Office on Dec. 15, 2014, the entire content of which is hereby incorporated by reference in its entirety.

### BACKGROUND

1. Field of the Disclosure

The present disclosure relates to an authentication method using biometric information and an electronic device therefor.

2. Description of the Related Art

In recent years, electronic devices have been developed that in addition to a simple call function, now include various functions such as the capturing of a picture or video, Internet communication, and the like. As the electronic devices include various functions that access and sometimes store private (personal) information such as bank and credit card account numbers, Social Security numbers, home address, the importance of security of private information is becoming spotlighted. In particular, keeping private information secure is very important for an electronic device that includes functions that may cause significantly damage when they are illegally used by criminals for Internet financial services and the like. As the importance of security for electronic device increases, recent electronic device are now being equipped with various security functions to limit unauthorized access by criminals.

For security, biological data may be used in identifying the user, and studies on security technologies using various pieces of biometric information such as a fingerprint, a voice, a retina, a face, or an iris. Among various biometric information elements, all irises of humans are different, and in particular, because they cannot be easily forfeited and rarely change during lifetime, a security technology using irises is being spotlighted.

If wireless payment systems are commercialized, payments can be performed for requests for payments by Point Of Sales (POS) systems through simple procedures. Then, if a system that requested a payment is not authenticated, a payment may be approved for a request for payment made by an unknown malicious system. Furthermore, payment information transmitted from an electronic device of the user to the system may be intercepted by another unauthenticated electronic device. Very often the sender will not be able to void out such as intercepted payment and the money is lost due to the fraud. Moreover, as a current electric device, for example, a smartphone increasingly interworks with a plurality of electronic devices, for example, wearable devices or tablet PCs, and all electronic devices should be authenticated prior to being granted access to security information. Therefore, there is a need for improved authentication services for electronic device, particularly portable and handheld devices that wirelessly communicate.

### SUMMARY

The present disclosure provides a method and an apparatus for effectively authenticating an electronic device that interworks with another electronic device using biometric information.

The present disclosure also provides a method and an apparatus for reducing the danger associated with illegal uses (i.e. fraud) of an electronic device that requested a payment during a payment by authenticating the electronic device through the use of biometric information transmitted from the electronic device.

The present disclosure also provides an authentication method using biometric information in which a first electronic device receives biometric information and a second electronic device performs the authentication based on the biometric information of the first electronic device, and an electronic device therefor.

In accordance with another aspect of the present disclosure, there is provided an authentication method using biometric information in an electronic device, the authentication method including: receiving biometric information from an external electronic device; performing an authentication for the received biometric information based on the biometric information stored in the electronic device; and transmitting the authentication result to the external electronic device such that the external electronic device performs a predesignated operation.

In accordance with another aspect of the present disclosure, there is provided an electronic device for performing an authentication method using biometric information, the electronic device including: a communication interface that receives biometric information from an external electronic device; a memory that stores the biometric information; and a controller configured to perform an authentication on the received biometric information based on the stored biometric information, and controls the communication interface to transmit the authentication result to the external electronic device such that the external electronic device performs a predesignated operation.

According to various embodiments of the present disclosure, authentication can be promptly and effectively performed by separately performing input and authentication of biometric information in different electronic devices.

According to a payment system according to various embodiments of the present disclosure, the danger of the illegal use of an electronic device that requested a payment by a third person can be prevented by authenticating the user of the electronic device using biometric information transmitted from the electronic device. In addition, the present disclosure can be utilized for a user authentication for various services such as a product purchase and payment services associated with multiple vendors such as a shopping mall, an entry control service associated with a digital door lock system, and a health diagnosis service and/or urgent care provider.

In addition, according to various embodiments of the present disclosure, an electronic device of the user can be effectively and accurately authenticated based on biometric information received through another electronic device that interworks with the electronic device of the user to identify the user.

### BRIEF DESCRIPTION OF THE DRAWINGS

The above and other aspects, features, and advantages of the present disclosure will become more apparent to a person of ordinary skill in the art from the following detailed description taken in conjunction with the accompanying drawings, in which:

FIG. 1 illustrates a network environment including an electronic device according to various embodiments of the present disclosure;

FIG. 2 is a block diagram of a program module according to various embodiments of the present disclosure;

FIG. 3 is a block diagram illustrating internal configurations of an external electronic device for receiving biometric information and an electronic device for performing a biometric authentication according to various embodiments of the present disclosure;

FIG. 4 and FIG. 5 are diagrams respectively illustrating a biometric authentication mode according to various embodiments of the present disclosure;

FIG. 6 is a diagram exemplifying information which is transmitted and received between a second external electronic device for receiving biometric information and an electronic device in a biometric authentication mode according to various embodiments of the present disclosure;

FIG. 7 is a diagram exemplifying information which is transmitted and received between a first external electronic device for receiving biometric information and an electronic device in a biometric authentication mode according to various embodiments of the present disclosure;

FIG. 8 is a flowchart illustrating operations of an electronic device and a second external electronic device in a biometric authentication mode for providing payment information from the electronic device to the second external electronic device according to various embodiments of the present disclosure;

FIG. 9 is a flowchart illustrating operations of an electronic device and a second external electronic device in a biometric authentication mode for providing security information from the electronic device to the second external electronic device according to various embodiments of the present disclosure;

FIG. 10A, FIG. 10B and FIG. 10C are exemplary views illustrating an operation of the user for performing a biometric authentication between an electronic device and a first external electronic device according to various embodiments of the present disclosure;

FIG. 11 is a flowchart illustrating operations of an electronic device and a first external electronic device in a biometric authentication mode for controlling an operation of the first external electronic device according to various embodiments of the present disclosure;

FIG. 12 is a flowchart illustrating operations of an electronic device and a first external electronic device in a biometric authentication mode for determining the same user according to various embodiments of the present disclosure;

FIG. 13 is a flowchart illustrating a discovery operation for starting a biometric authentication mode between an electronic device and a first external electronic device according to various embodiments of the present disclosure; and

FIG. 14 is a block diagram of an electronic device according to various embodiments of the present disclosure.

### DETAILED DESCRIPTION

Various embodiments of the present disclosure will now be described herein with reference to the accompanying drawings. However, it should be understood that there is no intent to limit the present disclosure to the particular forms disclosed herein; rather, the present disclosure including the appended claims should be construed to cover various modifications, equivalents, and/or alternatives of embodiments of the present disclosure. In the description of the drawings, similar reference numerals may be used in other drawings to designate similar elements.

In the present disclosure, the expression “have”, “may have”, “include” or “may include” refers to existence of a corresponding feature (e.g., numerical value, function, operation, or components such as elements), and does not exclude the existence of additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. The expressions may be used to distinguish a component element from another component element. For example, a first user device and a second user device may indicate the presence of different user devices regardless of the sequence or importance thereof. In addition, a first element may be termed a second element, and similarly, a second element may be termed a first element without departing from the scope of the present disclosure including the appended claims.

When it is disclosed herein that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). Conversely, when one component element is “directly coupled” or “directly connected” to another component element, it may be construed that a third component element does not exist between the first component element and the second component element.

The expression “configured to” used in the present disclosure, along with other expressions such as “suitable for”, “having the capacity to”, “designed to”, “adapted to”, “made to”, or “capable of” according to the situation a referring. to statutory subject matter The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations, or the other expressions user herein may refer to or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure including the appended claims. As used herein, the singular forms may include the plural forms as well, unless the context clearly indicates otherwise. Unless defined otherwise, all terms used herein, including technical and scientific terms, have the same meaning as those commonly understood by a person of ordinary skill in the art to which the present disclosure pertains. Such terms as those defined in a generally used technical dictionary are to be interpreted to have the meanings equal to the contextual meanings in the relevant field of the art, and are not to be interpreted to have ideal or excessively formal lexicographic meanings unless clearly defined in the present disclosure. For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, just to name some non-limiting possibilities.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments of the present disclosure will be described with reference to the accompanying drawings. In the present disclosure, the term “user” may indicate a person using an electronic device or a device (e.g. an artificial intelligence electronic device) using an electronic device.

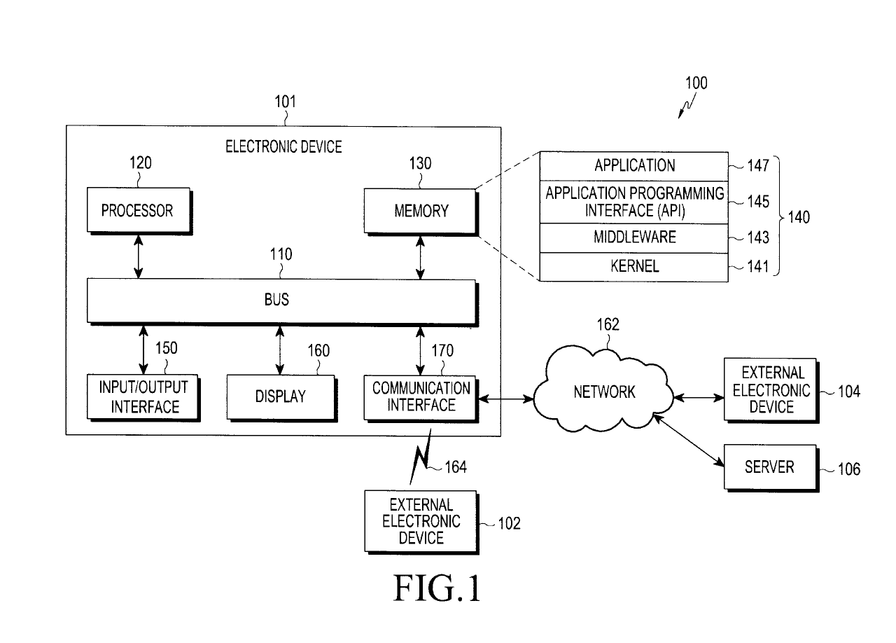

Referring now to FIG. 1, an electronic device 101 in a network environment 100 according to various embodiment of the present disclosure will be described. The electronic device 101 may include a bus 110, a processor 120, a non-transitory memory 130, an input/output interface 150, a display 160, and a communication interface 170. In some embodiments, the electronic device 101 may not employ at least one of the components or may further include another component.

For example, the bus 110 may include circuitry that connects the components 120 to 170 and performs communication (for example, of control messages and/or data) between the components 120 to 170.

The processor 120, which comprises hardware circuitry such as a semiconductor configured for operation, may include at least one of a central processing unit (CPU), an application processor (AP), and a communication processor (CP). For example, the processor 120 may execute calculation or data processing of controls and/or communications of at least one another component of the electronic device 101.

The processor 120 may be referred to as a controller, or may include the controller as a part thereof. Both the processor and controller do not constitute software per se under their broadest reasonable interpretation.

The processor 120 according to various embodiments of the present disclosure may control an operation of identifying an external electronic device coupled or electrically connected to the electronic device 101, authenticating the external electronic device based on biometric information received from the external electronic device, and transmitting the authentication result to the external electronic device. When the external electronic device is not paired with the electronic device 101, the electronic device may discover an electronic device having the same account information (for example, a user account, an email account, a web account, or the like) within a range allowing a wireless communication network and then send an authentication result that allows the external electronic device to perform a predetermined operation. The biometric information may comprise any biometric information, such as iris information, fingerprint information, voice information, or pulse information, just to name a few non-limiting possibilities by which the user can be identified.

Then, for example, when the identified electronic device is a Point Of Service device, the authentication result may include payment information. Furthermore, when the identified electronic device is, for example, a wearable device, the authentication result may include security information or an application execution instruction such as unlocking.

The non-transitory memory 130 may include a volatile and/or nonvolatile memory. For example, the memory 130 may store instructions or data related to at least one another component of the electronic device 101. According to one embodiment, the non-transitory memory 130 may store machine executable code and/or a program 140. For example, the program 140 may include a kernel 141, middleware 143, an Application Programming Interface (API) 145, and/or an application program (or an application) 147. At least one of the kernel 141, the middleware 143, and the API 145 may be called an operating system (OS).

For example, the kernel 141 may control or manage system resources (for example, the bus 110, the processor 120, or the memory 130) used to perform operations or functions implemented in the remaining programming modules (for example, the middleware 143, the API 145, and the application program 147). Furthermore, the kernel 141 may provide an interface through which the middleware 143, the API 145, and the application program 147 may access individual components of the electronic device 101 to control or manage the system resources.

For example, the middleware 143 may serve as an intermediary such that the API 145 or the application program 147 communicate with the kernel 141 to transmit/receive data. Furthermore, in regard to responding to task requests received from the application program 147, the middleware 143 may perform a control function (for example, scheduling or load balancing) for the task requests using, for example, a method of assigning a priority for using the system resources (for example, the bus 110, the processor 120, and the memory 130) of the electronic device 101 to at least one of the application program 147.

The Application Programming Interface 145 is an interface by which the applications 147 control functions provided from the kernel 141 or the middleware 143, and may include, for example, at least one interface or function (for example, instructions) for file control, window control, image processing, text control, or the like.

For example, the input/output interface 150 may function as an interface that may transmit instructions or data input from the user, or from another external device to the other components 120 to 140 and 160 to 170 of the electronic device 101. The input/output interface 150 may output instructions or data received from the other components 120 to 140 and 160 to 170 of the electronic device 101 to the user or another external device.

The display 160 may include a construction of, for example, a liquid crystal display (LCD), a light emitting diode (LED) display, an organic light emitting diode (OLED) display, a micro electromechanical system (MEMS), and an electronic paper display. For example, the display 160 may display various contents (for example, tests, images, videos, icons, or symbols) to the user. The display 160 may include a touch screen, and for example, may receive a touch, a gesture, a proximity, or a hovering input using an electronic pen or a part of the body of the user.

For example, the communication interface 170, which may include hardware such as transmitter, receiver, or transceiver, and an antenna, may set communication between the electronic device 101 and an external device 102, 104 (for example, a first external electronic device 102, a second external electronic device 104, or a server 106). For example, the communication interface 170 may be connected to the network 162 through wireless or wired communication and may communicate with the external device (for example, the second external electronic device 104 or the server 106). Furthermore, the communication interface 170 may set communication with the external device (for example, the first external electronic device 102) through the short-range wireless communication 164), and may be connected to the external device (for example, the second external electronic device 104) instead of the network 162, through the short range wireless communication 164. Here, the short range wireless communication may employ, for example, Beacon, WiFi Direct, Bluetooth, Baseband, or an audible/inaudible frequency.

For example, the wireless communication may employ at least one of LTE, LTE-A, CDMA, WCDMA, UMTS, WiBro, and GSM, for example, as a cellular communication protocol, just to name some non-limiting possibilities. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include a telecommunication network, for example, at least one of a computer network (for example, an LAN or WAN), the Internet, and a telephone network.

The first and second external electronic devices 102, 104 may be of the same or different types than the electronic device 101. In one embodiment, the server 106 may include a group of one or more servers.

According to various embodiments, some or all of the operations executed by the electronic device 101 may be executed by another one of or a plurality of electronic devices (for example, the external electronic devices 102, 104 or the server 106). According to one embodiment, when the electronic device 101 should perform a specific function or service automatically or by a request, the electronic device 101 may request at least one function related to the function or service from another device (for example, the external electronic devices 102,104 or the server 106) instead of directly executing the function or service or additionally. The other electronic device (for example, the external electronic devices 102, 104 or the server 106) may execute the requested function or additional function, and may transmit the result to the electronic device 101. The electronic device 101 may directly or additionally process the received result and provide the requested function or service. To achieve this, for example, a cloud computing technology, a distributed computing technology, or a client-server computing technology may be used.

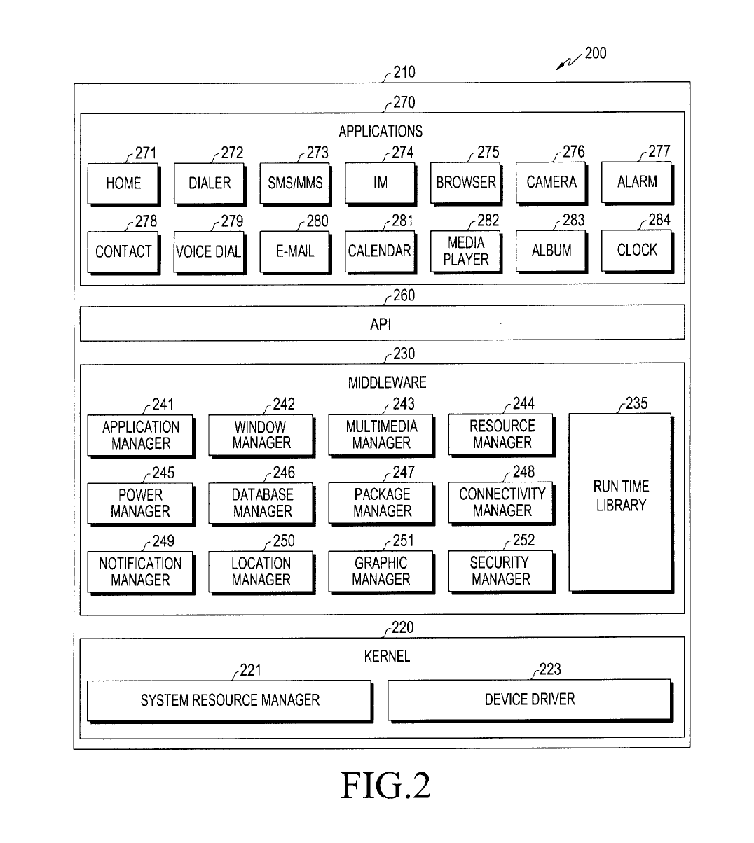

FIG. 2 is a block diagram 200 of a program module 210 according to various embodiments of the present disclosure. According to one embodiment, the program module 210 (for example, the program 140) is a non-transitory machine readable media that may include an operation system (OS) for controlling resources related to the electronic device (for example, the electronic device 101), and various applications (for example, an application program 147) driven on the operation system. The operation system may include Android, iOS, Windows, Symbian, Tizen, and Bada.

The program module 210 may include the kernel 220, the middleware 230, the application programming interface 260, and/or the application 270. At least a part of the program module 210 may be preloaded on the electronic device or may be downloaded from a server (for example, the server 106). The program module may be executed by a separate processor or by its own processor microprocessor.

The kernel 220 (for example, the kernel 141 of FIG. 1) may include, for example, a system resource manager 221 and a device driver 223. The system resource manager 221 may control, allocate, or retrieve the system resources. According to one embodiment, the system resource manager 221 may include a process management unit, a memory management unit, and a file system management unit. For example, the device driver 223 may include a display driver, a camera driver, a Bluetooth driver, a shared memory driver, a USB driver, a keypad driver, a WiFi driver, an audio driver, and an Inter-Process Communication (IPC) driver.

For example, the middleware 230 may provide a function commonly required by the application 270, or may provide various functions to the application 270 through the API 260 such that the application 270 efficiently uses the limited system resources in the electronic device. According to one embodiment, the middleware 230 (for example, the middleware 143) may include at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and a security manager 252

With continued reference to FIG. 2, the run time library 235 may include, for example, a library module that a compiler uses in order to add new functions through a programming language while the application 270 is executed. For example, the runtime library 235 may perform a function regarding an input/output management, a memory management, or an arithmetic function.

The application manager 241 may manage, for example, a life cycle of at least one application from among the applications 270. The window manager 242 may manage a GUI resource used in the screen. The multimedia manager 243 may detect a format required for reproducing various media files and perform an encoding or a decoding of a media file by using a codec suitable for the corresponding format. The resource manager 244 may manage resources such as a source code, a memory or a storage space of at least one application from among the applications 270.

The power manager 245 may manage a battery or power by operating together with a Basic Input/Output System (BIOS), and provide power information required for the operation. The database manager 246 may create, discover, or change a database that will be used in at least one of the applications 270. The package manager 247 may manage the installation or the updating of applications distributed in the form of a package file.

The connectivity manager 248 may manage wireless connection of, for example, Wi-Fi or Bluetooth. The notification manager 249 may display or notify an event such as a received message, an appointment, and a proximity notification to a user without disturbance. The location manager 250 may manage location information of the electronic device. The graphic manager 251 may manage graphic effects to be provided to a user and user interfaces related to the graphic effects. The security manager 252 may provide various security functions required for system security or user authentication. According to one embodiment, when the electronic device (for example, the electronic device 101) includes a phone function, the middleware 230 may further include a telephony manager for managing a voice or video communication function of the electronic device.

The middleware 230 may include a middleware module for combining various functions of the components. The middleware 230 may provide a module that is specified for the type of the operation system to provide a distinguished function. In addition, a few exiting component elements may be dynamically removed from the middleware 230, or new component elements may be added to the middleware 230.

For example, the API 260 (for example, the API 145) may be provided as another configuration according to the operation system with a set of API programming functions. When the OS corresponds to Android or iOS, for example, one API set may be provided for each platform, and when the OS corresponds to Tizen, for example, two or more API sets for platforms may be provided.

The application 270 (for example, the application program 147) may include, for example, a home 271, a dialer 272, an SMS/MMS 273, an instant message 274, a browser 275, a camera 276, an alarm 277, a contact 278, a voice dial 279, an email 280, a calendar 281, a media player 282, an album 283, a watch 284, and at least one application for providing a function of providing a healthcare (for example, measuring an amount of exercise or a blood glucose) or providing environment information (for example, atmospheric pressure, humidity, or temperature).

According to one embodiment, the application 270 may include an application (hereinafter, referred to as ‘an information exchange application’) for supporting exchange of information between the electronic device (for example, the electronic device 101) and the external electronic device (for example, the electronic devices 102, 104). The information exchange application may include, for example, a notification relay application for transmitting specific information to the external electronic device, or a device management application for managing the external electronic device.

For example, the notification relay application may include a function of transferring notification information generated in other applications (for example, the SMS/MMS application, the e-mail application, the health care application, or the environmental information application) of the electronic device to the external electronic device (for example, the external electronic devices 102, 104). Furthermore, the notification relay application may receive notification information, for example, from an external electronic device to provide the notification information for the user. The device management application may manage (for example, install, delete, or update), for example, at least some functions (for example, turning external electronic device (or some elements) on or off, or adjusting the brightness (or resolution) of a display) of an external electronic device (for example, the external electronic device 102 or 104) that communicates with the electronic device 101, applications performed in the external electronic device, or services (for example, a phone call service, or a messaging service) provided in the external electronic device.

According to one embodiment, the application 270 may include an application (for example, a healthcare application) designated according to the external electronic device (for example, the attribute (the type of the electronic device as an attribute of the electronic device) of the external electronic device 102 or 104 is a mobile medical device). According to one embodiment, the application 270 may include an application received from the external electronic device (for example, the server 106 or the external electronic device 102 or 104). According to one embodiment, the application 270 may include a preloaded application or a third party application that may be downloaded from the server. The titles of the components of the program module 210 according to the embodiments of the present disclosure may be changed according to the type of the operation system.

According to various embodiments, at least a part of the program module 210 may be implemented by software, firmware, hardware, or a combination of two or more of them. At least a part of the program module 210 may be implemented (for example, executed), for example, by a processor (for example, the AP 210). At least some of the programming module 210 may include, for example, a module, a program, a routine, sets of instructions, or a process for performing one or more functions.

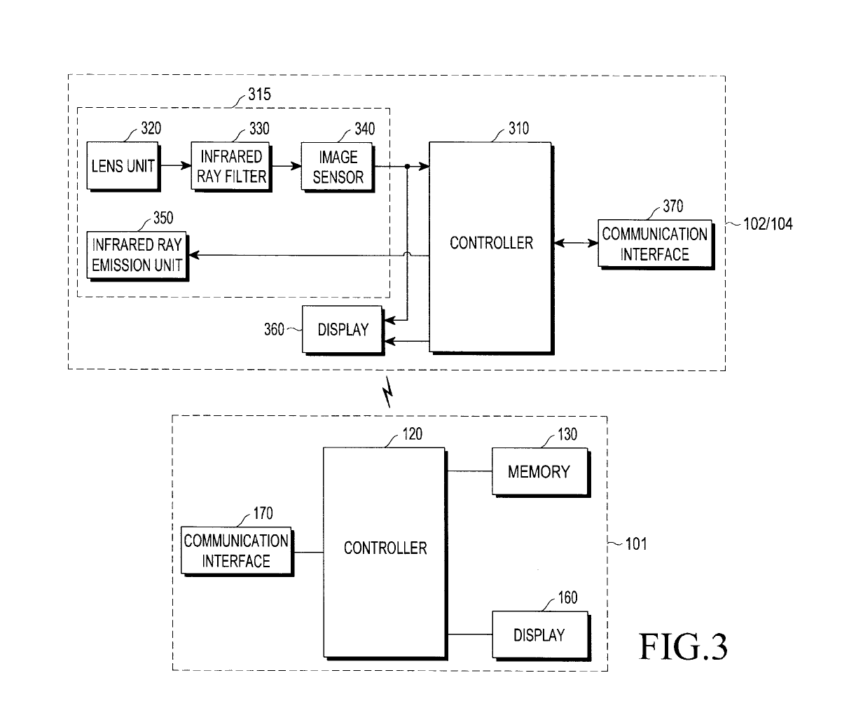

FIG. 3 is a block diagram illustrating internal configurations of an external electronic device for receiving biometric information and an electronic device for performing a biometric authentication according to various embodiments of the present disclosure.

In FIG. 3, the external electronic device may be the first external electronic device 102 or the second external electronic device 104 connected to the electronic device 101 of FIG. 1 through a short range wireless communication or a network. In the following described, it will be exemplified that the first external electronic device 102 is a wearable device and the second external electronic device 104 is a POS device. According to various embodiments of the present disclosure, the biometric information may include at least one of iris information, eye information, fingerprint information, face information, hand information, wrist information or blood vessel (vein) information.

Although FIG. 3 illustrates the external electronic device 102, 104 includes the components for receiving an iris image to exemplify iris information as the biometric information. Alternatively, the external electronic device may include components for receiving fingerprint information instead of iris information. Alternatively, the external electronic device may include components for receiving complex biometric information including fingerprint information and iris information.

Referring now to FIG. 3, the external electronic device 102, 104 may include a controller 310, a camera module 315, a display 360, and a communication interface 370. The camera module 315 may include a lens unit 320, an infrared ray filter 330, an image sensor 340, and an infrared ray emission unit 350. According to one embodiment, the external electronic device 102, 104 may further include a module for detecting biometric information other than the iris information, and may include a module for detecting other biometric information instead of the camera module 315.

First, the camera module 315 may process an iris image acquired for recognizing an iris to display the iris image on the display 360 under the control of the controller 310 or independently from the controller 310. In other words, the camera module 315 may set an iris recognition mode, may generate an image obtained by capturing a subject (for example, the face of the user) by controlling the image sensor 340. The camera module 315 or the controller 310 may detect an image area including at least a part of the iris, for example, an iris area from the generated image.

The camera module 315 or the controller 310 may determine guide information corresponding to the detected iris area, and may provide the user with the determined guide information. The guide information may be information for informing the user of an appropriate location of the iris in the image used for recognition of the iris. The camera module 315 or the controller 310 may apply a predetermined image effect to the detected iris area, and may generate an image to which an image effect is applied to display the generated image on the display 360. The image effect may be processing of an image by which only the form or shape of the detected iris area can be identified.

In more detail with reference to FIG. 3, the lens unit 320 of the camera module 315 may adjust the focus of the lens to a preset value in response to a photographing control signal by the controller 310, and penetrates an optical signal reflected from a subject (not shown).

The infrared ray emission unit (or InfraRed Emitting diode (IRED)) 350 may be switched on or off in response to an infrared ray photographing control signal by the controller 310. The infrared ray emission unit 350 may irradiate light of a specific wavelength band, that is, light of an infrared ray band to a subject when being switched on. The infrared ray photographing control signal may be a signal for photographing an infrared ray picture for an iris.

The infrared ray filter 330 may pass an optical signal of the infrared ray band from among optical signals that are incident through the lens unit 320 after being reflected from a subject (not illustrated).

The image sensor 340 may convert optical signals passing through only the lens unit 320 into image signals during a general photographing operation to output the image signals, and may convert optical signals of an infrared ray band passing through the lens unit 320 and the infrared ray filter 330 into infrared image signals to output the infrared image signals during an infrared ray photographing operation. Here, the camera module 315 may be disposed in the external electronic device 102, 104. Alternatively, the camera module 315 may be disposed at an independent location outside of the external electronic device 102, 104. According to one embodiment, the camera module 315 may be separated from the external electronic device 104 if the external electronic device 104 is a POS device or the like, and may be connected to the external electronic device 104 in a wired way.

The display 360 may include a touch screen or the like, and may provide a user interface associated with photographing of an iris. Furthermore, when the display 360 is a touch screen, the display 360 may include a fingerprint sensor for receiving a fingerprint. In addition, according to various embodiments of the present disclosure, the display 360 may display a preview screen for photographing an iris under the control of the controller 310, and may display a recognition execution screen using the iris authentication result. For example, the display 360 may display a recognition execution screen such as a payment approval screen or a unlocking screen.

The communication interface 370 may transmit an unprocessed or processed iris image to the electronic device 101. For example, if the iris image is acquired, the controller 310 may perform encoding (or encryption) on the iris image by reducing the acquired iris image and converting the reduced iris image to an integrated image.

For example, the controller 310 may receive an instruction or a request from the above-mentioned components (for example, the camera module 315, the display 360, and the communication interface 370), may decode the received instruction, and may execute calculation or data processing according to the decoded instruction.

The controller 310 according to various embodiments of the present disclosure may control an operation according to reception of an authentication result response from the electronic device 101 in response to transmission of an iris image through the communication interface 370. For example, when the authentication result response includes payment information, the controller 310 may perform an operation according to approval of a payment. Furthermore, when the authentication result response is security information, the security information may be used in all security operations that require authentication. In addition, when the authentication result response includes an application execution instruction, an application operation, for example the releasing of a locked state may be performed.

Meanwhile, operations of the components of the electronic device 101 in response to the transmission of an iris image will be described below.

The communication interface 170 may receive the iris information of an iris image in the form of raw data or processed iris information from the external electronic device 102, 104. The communication interface 170 may receive identification information of the external electronic device 102, 104 together with the iris information. The identification information may be used when the electronic device 101 identifies a target to which an authentication result will be transmitted.

The controller 120 may authenticate the received iris information based on the iris information stored in the non-transitory memory 130, and if the authentication is completed, control the communication interface 170 to transmit the authentication result such that the external electronic device 102, 104 performs a predesignated operation. Then, the authentication result may be transmitted to a corresponding external electronic device corresponding to the identification information received together with the iris information.

For example, it may be determined whether or not the iris image received from the external electronic device 102, 104 is the same as the iris image stored in the non-transitory memory 130 of the electronic device 101. If the iris image received from the external electronic device 102, 104 is the same as the iris image stored in the non-transitory memory 130 of the electronic device 101, it may be determined that the authentication for the external electronic device 102 or 104 is successful. An operation of determining whether the stored iris image is the same as the received iris image may be an operation of determining whether the image matching ratio between the received iris image and the stored iris image is equal to or greater than a predetermined ratio. For example, a total number of characteristic points of the stored iris image matching characteristic points of the received iris image may be calculated, and a ratio of the total number of the matched characteristic points to a predetermined threshold value (for example, a number of all characteristic points of the stored iris image) may be determined as the image matching ratio.

According to one embodiment, the non-transitory memory 130 may store and register at least one biometric information element of the user. Here, the biometric information may be stored in the form of one or more feature pattern (or one or more characteristic pattern/point) of a biometric image acquired for each of the users, and the one or more feature pattern may be at least a part or a whole of the entire pattern(s) of the biometric image. The non-transitory memory 130 may store a biometric information conversion algorithm for converting the biometric image for the user into one or more feature pattern such as an iris code or a template. The non-transitory memory 130 may provide data corresponding to a comparison reference during authentication, and may store an algorithm for the comparison.

When the external electronic device 102, 104 is a POS device that requests payment, the authentication result may include at least one of payment information and security information. Furthermore, when the external electronic device 102, 104 is a wearable device that interworks with the electronic device, the authentication result may include an instruction of controlling an operation of the wearable device. Then, the instruction of controlling an operation of the wearable device may include at least one of an unlocking instruction and an application execution instruction.

Generally, a method of recognizing an image of an iris may include discovering the center of a pupil by detecting a circular border, determining the border of the iris by identifying a bright change point, extracting an iris part by calculating the radius of the iris, and coding the pattern of the extracted iris part in the form of 256 bytes. In various embodiments of the present disclosure, an operation of extracting the iris part of the image and coding the image of the extracted iris part in a predetermined form may be implemented by the external electronic device 102,104. When the iris image obtained by extracting the iris part is directly transmitted to the electronic device 101, an operation of coding the iris image may be implemented by the electronic device 101.

Accordingly, the iris image may be converted into an iris template or an iris code, and the controller 120 of the external device 102 may store the iris template as user registered data in an enrollment step. Meanwhile, in a verification step, the converted iris template and the iris template stored in the non-transitory memory 130 may be compared with each other such that an authentication success can be returned when the coincidence of them (or a matching ratio between them) is within a predetermined threshold value or more. Meanwhile, when the coincidence does not exceed the predetermined threshold, an authentication failure may be returned.

Accordingly, when the authentication is successful, the controller 120 may make a control to transmit an authentication result response including at least one of, for example, payment information, security information, and an application execution instruction to the external electronic device 102, 104 through the interface 170 based on the authentication result. In this way, authentication can be promptly and effectively performed by separately performing input and authentication of biometric information in different electronic devices.

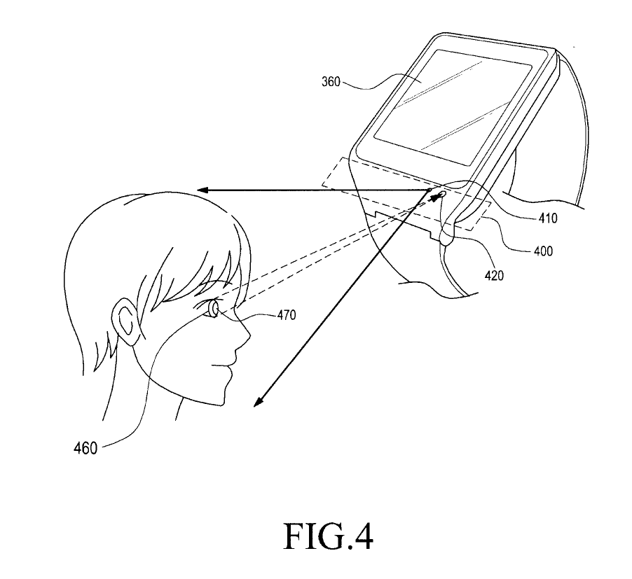

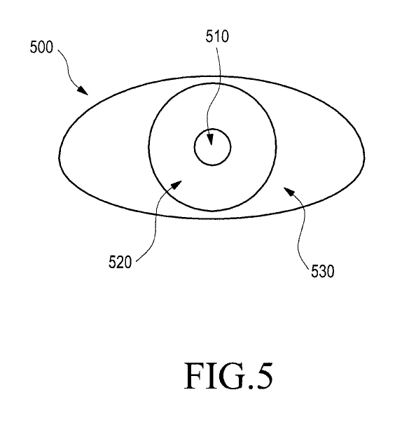

FIGS. 4 and 5 are diagrams illustrating a biometric authentication mode according to various embodiments of the present disclosure. FIG. 4 exemplifies an external electronic device 102 of a wearable device type.

Referring now to FIG. 4, a camera module including at least one of an infrared ray light source 410 and an infrared ray camera 420 may be disposed at a location of a bezel surrounding the display 360 of the external electronic device 102. FIG. 4 exemplifies in this case that the infrared ray light source 410 and the infrared ray camera 420 are disposed at a lower end of a front surface of the camera module. The disposition locations of the infrared ray light source 410 and the infrared ray camera 420 may be freely modified and changed as long as at least one of the infrared ray light source 410 and the infrared ray camera 420 may be coupled to the body of the external electronic device 102 such that an image for a subject can be received. Although FIG. 4 exemplifies a disposition location of the camera module in the external electronic device 102 of a wearable device type, it may be freely modified and changed as long as the external electronic device 104 of a POS device type can capture an image of a subject, that is, an image of an eye.

First, with continued reference to FIG. 4, the infrared camera 420 may convert an optical image formed by an infrared ray reflected from a subject into a digital image to output the converted digital image, and the controller 310 may recognize a living body from the digital image. The living body may include one or more of an eye, an iris, a fingerprint, a face, a hand, a wrist, and/or blood vessel (a vein or the like).

Still referring to FIG. 4, the infrared ray light source 410 may irradiate an infrared ray to an eye 460 of the user, and may output an image for the iris 470 by photographing the eye 460. The controller 310 may transmit an image for the iris 470 to the electronic device 101 for authentication, and may compare stored iris information (an iris template, an iris code, an iris image, or the like) of the user with the iris image in the electronic device 101 to recognize the iris of the user.

Referring now to FIG. 5, the eye 500 of the user may have a pupil 510, an iris 520, and a sclera 530, the infrared ray light source 410 may irradiate an infrared ray to the eye 500 of the user, and the camera 420 (FIG. 4) may output an iris image by photographing the eye 500 of the user.

In this way, the iris recognition technology for outputting an iris image is a technology of authenticating a user using a donut-shaped iris pattern present between a central black pupil and a sclera (the white of the eye) of an eye of a person. An iris of a person has 266 measurable features, and it can be seen that a probability of the same iris is about 1/1078, which corresponds the highest level in distinguishing persons among known body authentication technologies. In addition, because the patterns of the irises of a person are created over about 18 months after he or she is born and are protected by the eyebrows, the eyelids, and the retinas, they are not changed for his or her lifetime, so that they have a consistency higher than those of other biometric features such as a fingerprint, a voice, a face, and a signature, all of which tend to change over the life of a person for various reasons.

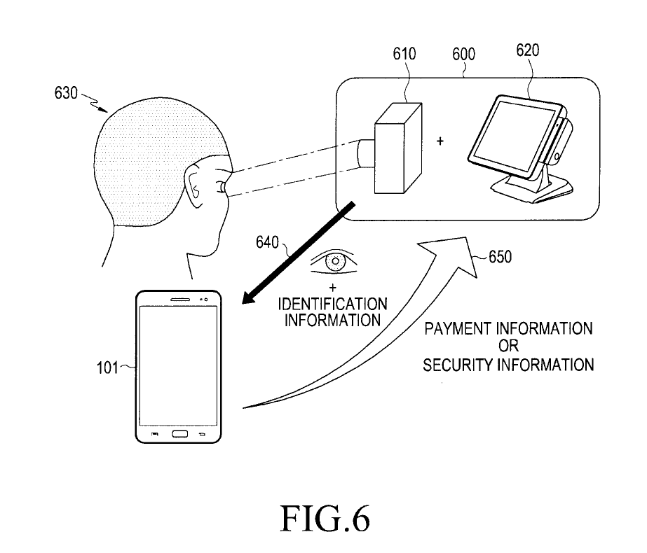

FIG. 6 is a diagram exemplifying information which is transmitted and received between a second external electronic device for receiving biometric information and an electronic device in a biometric authentication mode according to various embodiments of the present disclosure.

Referring now to FIG. 6, in a payment system 600 including a POS device 620 to which a camera module 610 is coupled, if the camera module 610 photographs an eye of the user 630, the payment system 600 may transmit identification information (for example, a device ID) 640 of the payment system 600 together with an iris image to the electronic device 101. In response, the electronic device 101 may authenticate the iris image and transmit the authentication result 650 to the POS device 620 of the payment system 600. Then, because the payment is requested by the POS device 620 of the payment system 600, the authentication result may include payment information or security information required for another authentication. Accordingly, the POS device 620 may also perform a predesignated operation such as a payment processing operation using payment information or security information. For example, a payment may be performed through the authentication procedure in response to a request for a payment made by the POS device. Furthermore, because the POS device 620 also sends identification information of the POS device 620 when an iris image is transmitted, the electronic device 101 may return an authentication result to the POS device 620 corresponding to the identification information.

Meanwhile, although FIG. 6 exemplifies a payment system 600 to which a camera module 610 is coupled for acquisition of an iris image, various modules may be coupled for authentication of the user. For example, a fingerprint sensor for acquiring a fingerprint, a microphone for receiving a voice of the user, a measurement sensor for measuring a pulse of the user, and/or the like may be added, and any module that can acquire biometric information of the user in this way may be applied.

The iris recognition technology is largely classified into an input part, a recognition part, and an application part, in which case the input part corresponds to a technology of controlling a structure, a focus, a photographing timing, and a light amount of a photographing unit, the recognition part corresponds to a step of extracting a contour of the iris, and extracting or matching a feature, and the application part corresponds to a service using the recognized iris. According to various embodiments of the present disclosure, the input part may be implemented in the external electronic device 102, 104, the recognition part may be implemented in the electronic device 101, and the application part may be implemented in the external electronic device 102, 104 or in the electronic device 101.

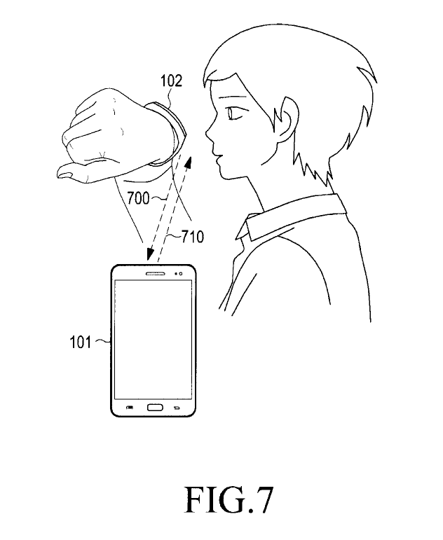

FIG. 7 is a diagram exemplifying information which is transmitted and received between a first external electronic device for receiving biometric information and an electronic device in a biometric authentication mode according to various embodiments of the present disclosure.

Referring to FIG. 7, the electronic device 101 may be a smartphone of the user, and the external electronic device 102 may be another accessory or a wearable device used in conjunction with the electronic device 101. When an iris recognition camera of the electronic device 101 is used, the user should adjust an angle of view while gripping the electronic device 101 with his or her hand such that the camera recognizes an iris. In general, when it is considered that an angle of view of the iris recognition camera is 15°, it may be troublesome to recognize an iris while lifting an electronic device having a large size. Furthermore, even if the performance of the camera develops such that the angle of view of the camera becomes wider later, it may be more highly available to recognize an iris using a device (for example, glasses, a watch, a ring, and a bracelet) worn on the body of the user rather than using a device that is heavier and larger than those of the wearable device.

Furthermore, for a security reason, an iris code should be managed in a separate security area such as a Trust Zone (TZ) or an embedded Secure Element (eSE), and it may be difficult for a wearable device having a relatively small capacity to have an iris code. However, because the wearable device also requires means for authentication, a device for authentication may be required instead of the wearable device. When a wearable device interworks with the electronic device 101, the electronic device 101 may authenticate an authority of the wearable device if iris information input to the wearable device that can photograph an iris easily as compared with the electronic device 101.

FIG. 7 exemplifies that in an external electronic device 102 of a wearable device type to which a camera module is coupled, the external electronic device 102 transmits identification information (for example, a device ID) 700 of the external electronic device 102 together with an iris image to the electronic device 101 if the camera module photographs an eye of the user. In response, the electronic device 101 may authenticate the iris image and return the authentication result 710 to the external electronic device 102. According to the authentication result, the external electronic device 102 or the electronic device 101 may perform a predesigned operation.

Because different operations may be performed according to the type of the external electronic devices seeking iris authentication, examples of the operations performed by the external electronic devices 102 and 104 and the electronic device 101 will be described hereinbelow.

If the first device obtains an iris image, the obtained iris image is transmitted to the second device, and then the iris image information sent by the first device may be raw data, image forms, coded data, encoded information, or encrypted information. In this way, the iris information may be transmitted in the form of raw data of the iris image, or may be transmitted in a processed form using any one method of coding, encoding or encryption.

The format of the transmitted iris image information should be changed to be compared with the iris stored in the second device, which may be referred to as a template or coding/encoding. It is determined whether information matching with the information stored as the obtained iris code is present, the second device transmits payment related information to the first device that recognized the iris to perform a payment.

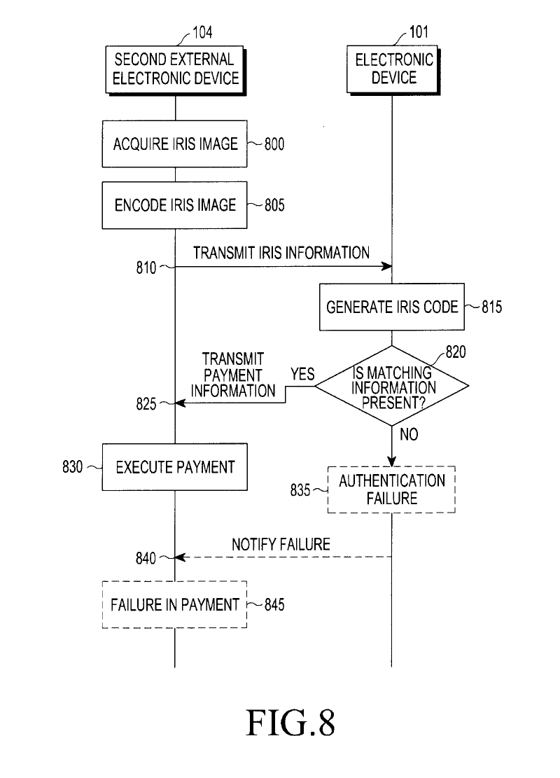

FIG. 8 is a flowchart illustrating an operative example of an electronic device and a second external electronic device in a biometric authentication mode for providing payment information from the electronic device to the second external electronic device according to various embodiments of the present disclosure. In FIG. 8, the electronic device 101 may be a general wireless communication device such as a smartphone, and the second external electronic device 104 may be a POS device for providing a Point Of Sales (POS) system or a shop.

The second external electronic device 104, such as a POS system in a shop, at operation 800 may acquire an iris image of a person that requests a payment using a camera connected to the second external electronic device 104. At operation 805, the second external electronic device 104 may (optionally) encode (or encrypt) the iris image 805, and at operation 810 may transmit the encoded iris image to the electronic device 101 for authentication. The second external electronic device 104 may also segment the iris image, may convert the segmented iris image into an iris template or an iris code through an encoder, and may transmit the converted iris template or iris code to the electronic device 101 or directly transmit the iris image.

At operation 810, the iris information that underwent the processing process is transmitted from the second external electronic device 104 to a device of a payer, that is, the electronic device 101 of the user, and the transmission method may be performed using a short range wireless communication method.

If the iris information is received by the electronic device 101, at operation 815 an iris code for the iris information may be generated such that it is identified whether the received iris information coincides with iris information of the user stored in the memory 130.

Accordingly, the electronic device 101 that received the iris information may identify whether the iris information coincides with the iris information of the user stored in the non-transitory memory 130 based on an iris recognition algorithm in the electronic device 101. The electronic device 101 may compare a matching ratio between the received iris information and the stored iris information with a predetermined threshold value.

At operation 820, if it is determined that the iris information coincides with the iris information of the user stored in the memory 130, that is, information matching with the iris information is present, then at operation 825 payment information stored in the electronic device 101 may be transmitted to the second external electronic device 104.

Accordingly, with continued reference to FIG. 8, at operation 830 the second external electronic device 104 such as a POS system, may execute a payment with the payment information. Here, the payment information may include card information.

Meanwhile, at operation 820, when information matching with the iris information is not present, then at operation 835 the electronic device 101 determines that an authentication failure has occurred, then at operation 840 the electronic device 101 may notify the second external device 102 of the authentication failure. In response, at operation 845 the second external electronic device 104 indicates a failure in a payment. Accordingly, the display 360 of the second external electronic device 104 may display contents notifying that the request is a request for a payment by an unauthenticated user. In addition, a danger of an illegal use of a third person can be prevented by authenticating the external electronic device 104 or the user who requested the payment using the iris information transmitted from the external electronic device 104 that requested a payment.

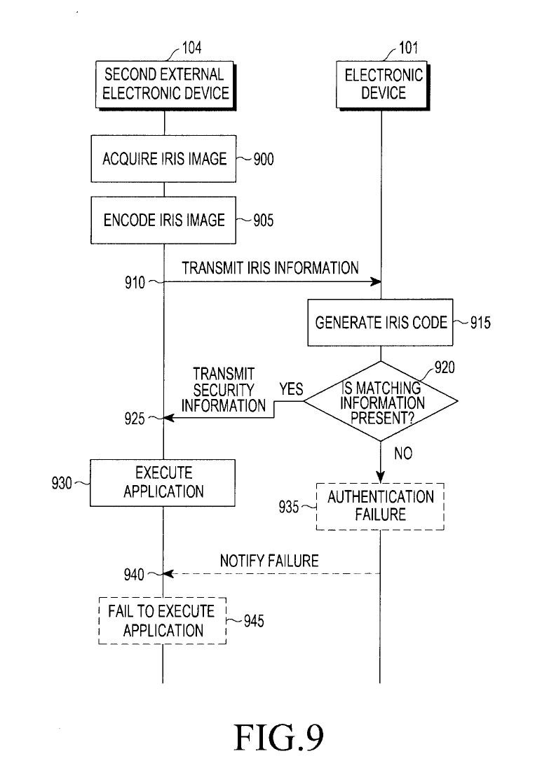

FIG. 9 is a flowchart of operations of an electronic device and a second external electronic device in a biometric authentication mode for providing security information from the electronic device to the second external electronic device according to various embodiments of the present disclosure.

Referring now to FIG. 9, because the operations 900 to 920 of FIG. 9 are the same as the operations 800 to 820 of FIG. 8, a detailed description thereof will be omitted. Meanwhile, although FIG. 8 exemplifies that payment information is provided to the second external electronic device 104 that requested a payment, an authentication result may include all security information elements that require authentication, in addition to the payment information, when the authentication result is returned.

Accordingly, when information matching with the iris information is present, the user is regarded as a user to which an access to security information is allowed, and the electronic device 101 may transmit security information at operation 925. At operation 930, the second external electronic device 104 may execute an application based on security information. Meanwhile, at operation 920 when information matching with the iris information is not present, then at operation 935 the electronic device 101 determines that an authentication failure has occurred, then the failure in authentication may be notified in step 940. In response, the second external electronic device 104 at operation 940 receive a notification of failure, and at operation 945 fails in an execution of the application. Here, the security information may include individual information such as a user name, a resident registration number, and/or financial trade means information.

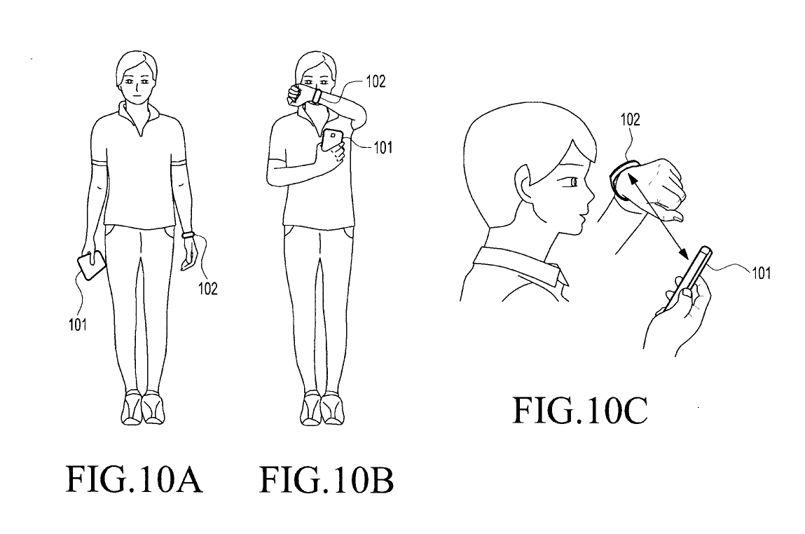

FIG. 10 is an exemplary view illustrating an operation of the user for performing a biometric authentication between an electronic device and a first external electronic device according to various embodiments of the present disclosure.

A wearable electronic device 102 is worn on a wrist of the user as illustrated in FIG. 10A, and in a state in which an electronic device 101 such as a smartphone is gripped by the other hand of the user, an eye may be photographed while the wearable electronic device 102 approaches the face of the user to maintain a predetermined distance with the face to photograph an iris as illustrated in FIG. 10B. Then, a preview screen for photographing an iris maybe viewed through the display of the wearable electronic device 102. Here, a camera module is included in the wearable electronic device 102, and the wearable electronic device 102 is connected to the electronic device 101 in a short range communication method.

Because the wearable electronic device 102 and the electronic device 101 are connected to each other, the wearable electronic device 102 may transmit iris information to the electronic device 101. As illustrated in FIG. 10C, while an iris is photographed, a state of the user such as a photographing posture or a photographing location of the user may be identified while the user views a photographed part of the user displayed on the display of the electronic device 101 while maintaining a predetermined distance between an eye and the wearable electronic device 102 with one hand of the user to photograph the iris using the wearable electronic device 102.

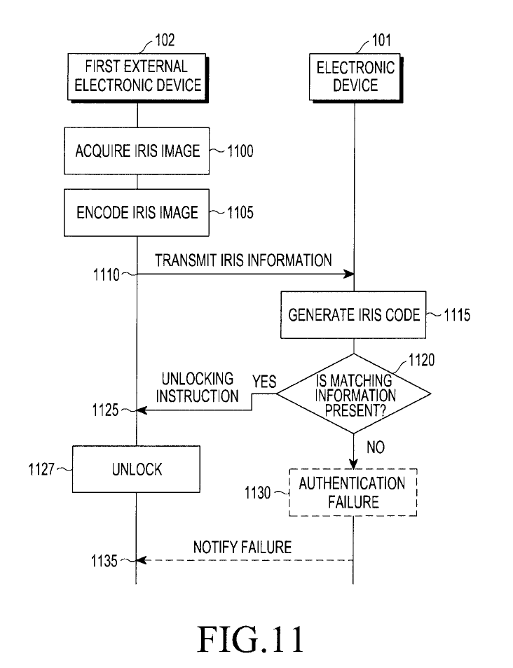

FIG. 11 is a flowchart illustrating an operative example of an electronic device and a first external electronic device in a biometric authentication mode for controlling an operation of the first external electronic device according to various embodiments of the present disclosure. In FIG. 11, the electronic device 101 may be a general wireless communication device such as a smartphone, and the first external electronic device 102 may be a wearable device.

Referring now to FIG. 11, at operation 1100, while the electronic device 101 is connected to the first external electronic device 102, the first external electronic device 102 may acquire an iris image of the user who requests authentication using a camera included in the first external electronic device 102. At operation 1105, the first external electronic device 102 may encode (or encrypt) the iris image. Then, the encoding process may be omitted in consideration of a processing capacity of the first external electronic device 102. The first external electronic device 102 may have a limit in a capacity of the memory so that an iris code necessary for authentication cannot be stored. Accordingly, at operation 1110 the first external electronic device 102 may transmit a raw iris image or processed iris information to the electronic device 101 such that an iris recognition operation can be performed by the electronic device 101 based on the iris information. Then, the first external electronic device 102 may send the iris information to a predesignated electronic device, that is, the electronic device 101 of the user, or discovers an electronic device 101 connected through the same account (for example, a user account, an email account, a web account, or the like) and send the iris information to the electronic device 101.

Accordingly, at operation 1115, after generating an iris code based on the received iris information, the electronic device 101 may compare the generated iris code with the iris information of the user stored in the electronic device 101.

If at operation 1120, it is determined that iris information matching with the received iris information, the authentication is successful so that the first external electronic device 102 may be accessed.

Accordingly, at operation 1125 the electronic device 101 may transmit an unlocking instruction to the first external electronic device 102 as an operation of allowing an access, and in response, at operation 1127, the first external electronic device 102 may perform an unlocking operation. Although FIG. 11 exemplifies that the unlocking operation is performed by the first external electronic device 102, the electronic device 101 also may perform an unlocking operation.

For example, if the user is authenticated by transmitting the input iris information to the smartphone using the wearable device, the user is an allowed user who can use the wearable device or the smartphone and thus at least one of the wearable device and the smartphone may perform an unlocking operation.

Meanwhile, at operation 1120, when information matching with the received iris information is not present, at operation 1130 the electronic device 101 determines an authentication failure and at operation 1135 may notify the first external electronic device of a failure. Accordingly, the first external electronic device 102 maintains a locked state.

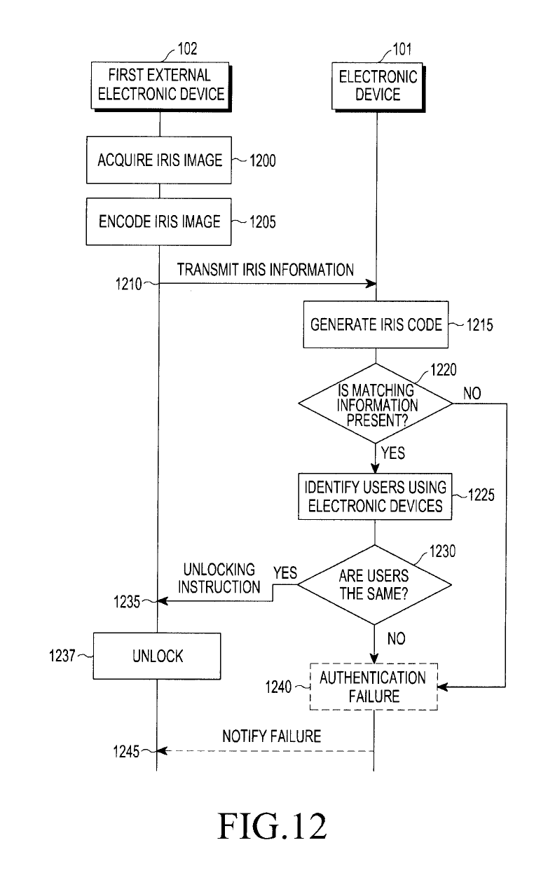

FIG. 12 is a flowchart of operations of an electronic device and a first external electronic device in a biometric authentication mode for determining the same user according to various embodiments of the present disclosure.

Referring now to FIG. 12, because the operations 200 to 1220 are the same as the operations 1100 to 1120 of FIG. 11, a detailed description thereof will be omitted. Meanwhile, if it is determined at operation 1220 that iris information matching with the received iris information is present, then at operation 1225 it may be identified whether the users of the electronic devices, that is, the electronic device 101 and the first external electronic device 102 are the same.

For example, an unlocked state may be directly released for an authenticated user as long as the user views the first external electronic device 102 such as the wearable device so that the electronic device 101 such as a smartphone or a tablet PC can be conveniently unlocked. In this case, the user can conveniently unlock the electronic device 101 without performing a separate input for an unlocking operation, such as an operation of inputting a password to the electronic device 101 to release the unlocked state of the electronic device 101.

With regard to identifying users using electronic devices at operation 1225, when the user intends to unlock the electronic device 101 by photographing an iris with the first external electronic device 102 for authentication, an unlocking operation cannot be achieved when the user does not actually use the electronic device 101. Accordingly, a method of determining whether the user using the first external electronic device 102 and the user using the electronic device 101 are the same may be required. To achieve authentication under such circumstances, according to various embodiments of the present disclosure, it may be identified through biometric information, account information, or sensor information other than the iris information as to whether the users are the same.

For example, methods of identifying the user of an electronic device 101 such as a tablet PC or a smartphone may include a method of using a sensor for detecting a fingerprint or a heart rate that can be obtained while the user grips the electronic device 101 or a method of using voice recognition information.

If at operation 1230 it is determined that the users are the same, then at operation 1235 the user who requested an authentication may transmit an unlocking instruction to the first external electronic device 102 such that the first external electronic device 102 can be used by the user. In response, at operation 1237, the first external electronic device 102 may perform an unlocking operation.

Meanwhile, when the users are not the same, at operation 1240 if is realized that an authentication failure has occurred, and at operation 1245 the first external electronic device 102 can be notified about the failure. Accordingly, the first external electronic device 102 maintains a locked state. Then, even if the first external electronic device 102 is not currently paired with the electronic device 101, the two electronic devices 101 and 102 may be unlocked at the same time if the electronic device 101 having the same account information as that of the first external electronic device 102 is near the first external electronic device 102.

For example, if the wearable device recognizes an iris by directing the eye towards the wearable device while the wearable device and the tablet PC are used, both of the wearable device and the tablet PC may be unlocked according to the iris recognition result, and when it is determined that the user currently using the tablet PC is not the user of the wearable device, only the wearable device may be unlocked.

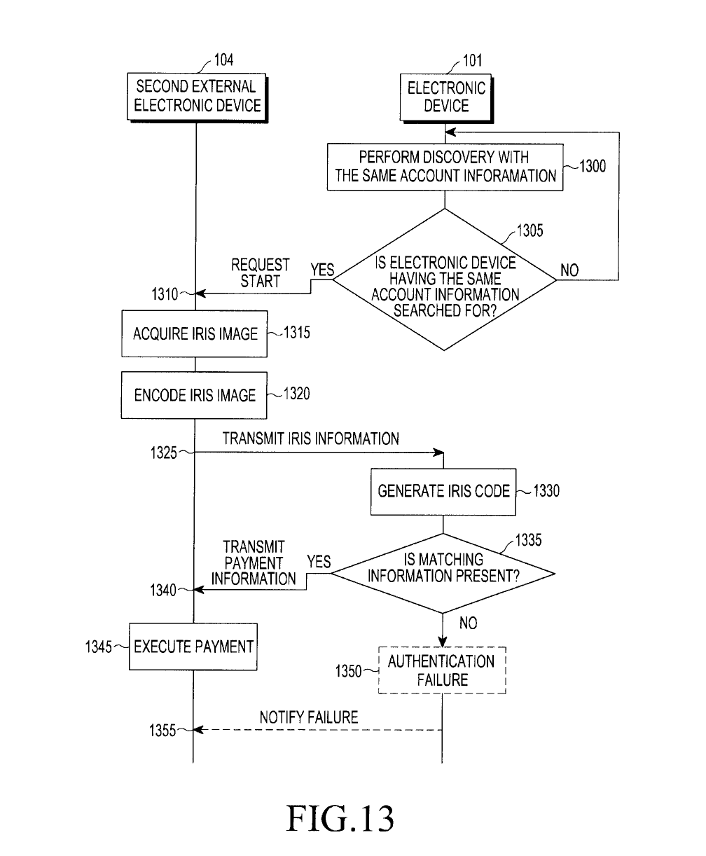

Meanwhile, in the method of identifying account information, an operation of discovering an electronic device having the same account may be performed before an iris is recognized, and will be described with reference to FIG. 13.

FIG. 13 is a flowchart illustrating a discovery operation for starting a biometric authentication mode between an electronic device and a second external electronic device according to various embodiments of the present disclosure.

Referring now to FIG. 13, at operation 1300 the electronic device 101 may perform an operation of discovering an electronic device having the same account information as that of the electronic device 101.

After determining at operation 1305 whether the electronic device has the same account information (for example, a user account, an email account, a web account, or the like) is searched for, and if the corresponding electronic device is searched for, then at operation 1310 a start of an iris authentication mode may be requested.

In response, at operation 1315 the second external electronic device 104 may acquire an iris image, and at operation 1320 may encode (or encrypt) the iris image, and at operation 1325 may transmit the iris information. Here, because the second external electronic device 104 may recognize the identification information of the electronic device 101 that requested a start of the iris authentication mode through a discovery operation, the iris information may be transmitted to the electronic device 101 corresponding to the identification information of the electronic device 101. Meanwhile, identification information of the second external electronic device 104 together with the iris information may transmitted such that the payment information is transmitted to a target device, that is, a device that requested a payment when the authentication of an iris is successful.

In response to the transmission of iris information, an operation of the electronic device 101 may be similar to an operation of FIG. 11. Meanwhile, at operation 1335, if iris information of the user matching with the iris information is present, and at operation 1340 payment information may be transmitted to the second external electronic device 104. Accordingly, at operation 1345 the second external electronic device 104 may perform a payment. Then, although FIG. 13 exemplifies that a payment is performed when the authentication of an iris is successful, a predefined operation may be performed between the electronic device 101 and the second external electronic device 104 in addition to the payment operation or even in lieu of a payment operation when the authentication of an iris is successful.

Meanwhile, at operation 1335, when information of the user matching with the iris information is not present, a failure in authentication is determined at operation 1350 and the second external electronic device can be notified at operation 1355.

For example, as a wireless payment system is commercialized, a payment system for informing an electronic device of the user of information such as a purchase list, a sum, and the like by setting the sum and the payment means in the POS device if an order is requested from the electronic device through a mobile communication. Accordingly, if a coffee is ordered in a café, a POS device sets a sum and a payment means, and the electronic device of the user may recognize information such as a purchase list and a sum through a mobile order scheme or the POS device.

Accordingly, the user of the electronic device who knows order information will input an operation for payment. Then, because the POS device of the shop may recognize identification information of the electronic device that made an order when a request for the order is received, a payment may be requested from the electronic device based on the identification information of the electronic device. Then, when the iris information is provided to the electronic device to receive payment information, the identification information of the POS device together with the iris information may be transmitted. Here, transmission and reception of information between the POS device and the electronic device may be made through a network or a short range wireless communication scheme.

If the electronic device of the user authenticates the iris information received from the POS device and the authentication is successful, payment information may be transmitted only to the POS device that sent the iris information. Then, because the payment information may be transmitted to the POS device that requested the payment using the identification information of the POS device, the payment can be safely performed.

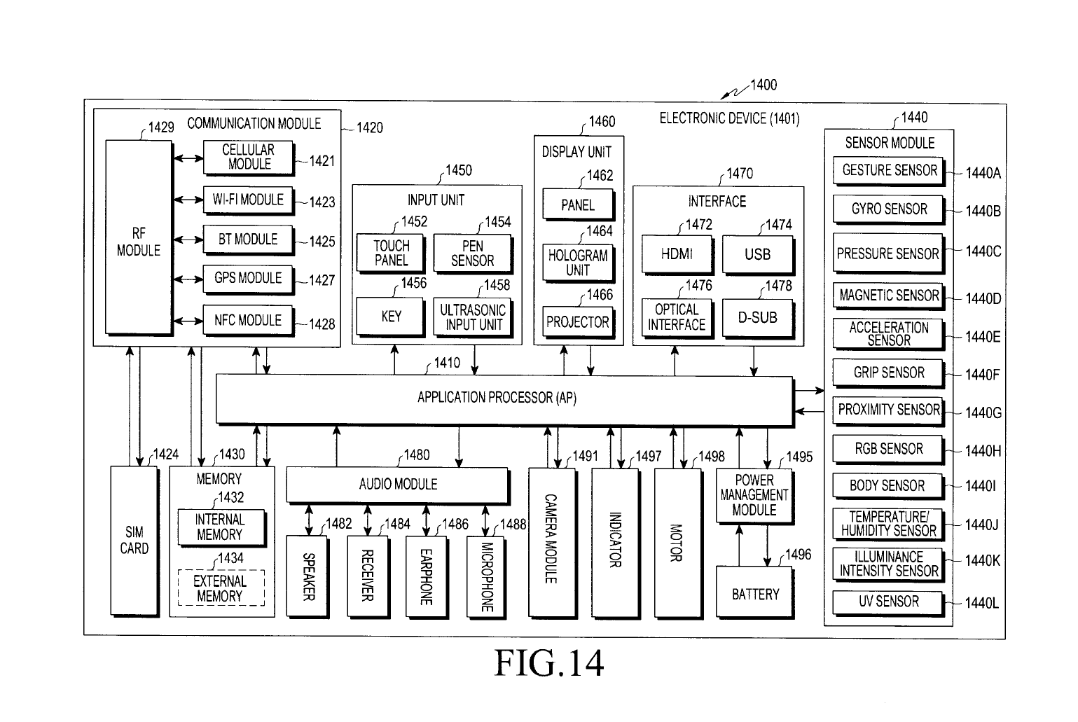

FIG. 14 is a block diagram 1400 of an electronic device according to various embodiments of the present disclosure.

The electronic device 1401 may include, for example, all or a part of the electronic device 101 shown in FIG. 1.

Referring now to FIG. 14, the electronic device 1401 may include at least one application processor 1410, a communication module 1420, a Subscriber Identification Module (SIM) card 1424, a non-transitory memory 1430, a sensor module 1440, an input unit 1450, a display unit 1460, an interface 1470, an audio module 1480, a camera module 1491, a power management module 1495, a battery 1496, an indicator 1497, and a motor 1498.

For example, the AP 1410 comprises circuitry configured for operation and may control a plurality of hardware or machine executable components connected to the AP 1410 by driving an operating system or an application program, to process various data. The AP 1410 may be implemented by, for example, a System on Chip (SoC). In one embodiment, the AP 1410 may further include a Graphic Processing Unit (GPU) and/or an image signal processor. The AP 1410 may include at least one (for example, the cellular module 1421) of the components illustrated in FIG. 14. The AP 1410 may load an instruction or data received from the at least one of the other components (for example, the volatile memory) in the memory to process the instruction or data, and may store various data in the nonvolatile memory.

The communication module 1420 may has a configuration that is the same as or similar to the communication interface 170 of FIG. 1. The communication module 1420 may include a cellular module 1421, a WiFi module 1423, a BlueTooth (BT) module 1425, a Global Positioning System (GPS) module 1427, a Near Field Communication (NFC) module 1428, and a Radio Frequency (RF) module 1429.

The cellular module 1421 may provide a voice communication, a video communication, a text message service, or an Internet service, for example, through a communication network. According to one embodiment, the cellular module 1421 may identify and authenticate an electronic device 1401 in a communication network by using, for example, a subscriber identification module (for example, the SIM card 1424). According to an embodiment, the cellular module 1421 may perform at least some of the functions which can be provided by the AP 1410. According to one embodiment, the cellular module 1421 may include a Communication Processor (CP).

Each of the Wi-Fi module 1423, the BT module 1425, the GPS module 1427, and the NFC module 1428 may include, for example, a processor for processing data transmitted/received through the corresponding module. In some embodiments, at least one (for example, two or more) of the cellular module 1421, the WiFi module 1423, the BT module 1425, the GPS module 1427, and the NFC module 1428 may be included in one Integrated Chip (IC) or an IC package.

For example, the RF module 1429 may transmit and receive a communication signal (for example, an RF signal). For example, the RF module 1429 may include a transceiver, a Power Amp Module (PAM), a frequency filter, a Low Noise Amplifier (LNA), or an antenna. In another embodiment, at least one of the cellular module 1421, the WiFi module 1423, the BT module 1425, the GPS module 1427, and the NFC module 1428 may transmit and receive an RF signal through a separate RF module 1429.

For example, the SIM card 1424 may include a card and/or an embedded SIM including a subscriber identification module, and may include an Integrated Circuit Card Identifier (ICCID) or subscriber information (for example, an International Mobile Subscriber Identity (IMSI)).

For example, the non-transitory memory 1430 may include an embedded memory 1432 or an external memory 1434. The internal memory 1432 may include at least one of a volatile memory (for example, a Dynamic Random Access Memory (DRAM), a Static RAM (SRAM), a Synchronous Dynamic RAM (SDRAM), and the like) a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like), and a hard disk drive or a Solid State Drive (SSD).

The external memory 1434 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 1434 may be functionally and/or physically connected to the electronic device 1401 through various interfaces.

The sensor module 1440 may measure a physical quantity or detect an operation state of the electronic device 1401, and may convert the measured or detected information to an electronic signal. The sensor module 1440 may include at least one of, for example, a gesture sensor 1,440A, a gyro sensor 1,440B, an atmospheric pressure sensor 1440C, a magnetic sensor 1440D, an acceleration sensor 1440E, a grip sensor 1440F, a proximity sensor 1440G, a color sensor 1440H (for example, a Red/Green/Blue (RGB) sensor), a biometric sensor 1440I, a temperature/humidity sensor 1,440J, an illumination sensor 1,440K, and an Ultra Violet (UV) sensor 1440M. Additionally or alternatively, the sensor module 1440 may include, for example, an E-nose sensor, an electromyography (EMG) sensor and electroencephalogram (EEG) sensor, an electrocardiogram (ECG) sensor, an Infrared (IR) sensor, an iris sensor, a fingerprint sensor, and the like. The sensor module 1440 may further include a control circuit for controlling one or more sensors included therein. In some embodiments, the electronic device 1401 may further include a processor configured to control the sensor module 1440 as a part of the AP 1410 or separately, so that the sensor module 1440 may be controlled while the AP 1410 is in a sleep state.

For example, the input device 1450 may include a touch panel 1452, a (digital) pen sensor 1454, a key 1456, or an ultrasonic input device 1458. The touch panel 1452 may use at least one of, for example, a capacitive scheme, a resistive scheme, an infrared scheme, and an ultrasonic scheme. The touch panel 1452 may further include a control circuit. The touch panel 1452 may further include a tactile layer to provide the user with a haptic reaction.

For example, the (digital) pen sensor 1454 may be a part of the touch panel 1452 or may include a separate recognition sheet. The key 1456 may include, for example, a physical button, an optical key or a keypad. The ultrasonic input unit 1458 is a unit that can identify data by generating an ultrasonic signal through an input tool and detecting a sonic wave through a microphone (for example, microphone 1488) in the electronic device 1401.

The display 1460 (for example, display 1460) may include a panel 1462, a hologram device 1464, or a projector 1466. The panel 1462 may include a configuration that is the same as or similar to the display 1460 of FIG. 1. The panel 1462 may be embodied to be, for example, flexible, transparent, or wearable. The panel 1462 may be also configured as one module together with the touch panel 1452. The hologram device 1464 may show a stereoscopic image in the air by using interference of light. The projector 1466 may project light onto a screen to display an image. For example, the screen may be located inside or outside the electronic device 1401. According to an embodiment, the display 1460 may further include a control circuit for controlling the panel 1462, the hologram device 1464, or the projector 1466.

The interface 1470 may include, for example, a High-Definition Multimedia Interface (HDMI) 1472, a Universal Serial Bus (USB) 1474, an optical interface 1476, or a D-subminiature (D-sub) 1478. The interface 1470 may be included in, for example, the communication interface 160 illustrated in FIG. 1. Additionally or alternatively, the interface 1470 may include, for example, a Mobile High-definition Link (MHL) interface, a Secure Digital (SD) card/Multi-Media Card (MMC) interface, or an Infrared Data Association (IrDA) standard interface.

The audio module 1480 may bidirectionally convert a sound and an electronic signal. At least some components of the audio module 1480 may be included in, for example, the input/output interface 150 illustrated in FIG. 1. The audio module 1480 may process voice information input or output through, for example, a speaker 1482, a receiver 1484, earphones 1486, the microphone 1488 or the like.

The camera module 1491 is a device that can take still and moving images, and according to an embodiment, may include one or more image sensors (for example, a front sensor or a rear sensor, a lens (not illustrated), an image signal processor (ISP), or a flash (for example, an LED or a xenon lamp).

For example, the power management module 1495 may manage power of the electronic device 1401. According to one embodiment, the power management module 1495 may include, for example, a Power Management Integrated Circuit (PMIC), a charger Integrated Circuit (IC), or a battery or fuel gauge. The PMIC may be implemented by a wired and/or wireless charging scheme. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added. The battery fuel gauge may measure, for example, the remaining amount, a charging voltage and current, or temperature of the battery 1496. The battery 1496 may include, for example, a rechargeable battery and/or a solar battery.

The indicator 1497 may show particular statuses of the electronic device 1401 or a part (for example, AP 1410) of the electronic device 1401, for example, a booting status, a message status, a charging status and the like, just to name a few non-limiting possibilities. The motor 1498 may convert an electrical signal into mechanical vibrations, and may generate vibrations or a haptic effect. Although not illustrated, the electronic device 1401 may include a processing unit (e.g., GPU) for supporting a mobile TV function. The processing unit for supporting the mobile TV may process media data according to a standard of Digital Multimedia Broadcasting (DMB), Digital Video Broadcasting (DVB), media flow or the like.

Each of the above-described elements of the electronic device 1401 may be implemented by one or more components and the name of the corresponding element may vary depending on the type of the electronic device 1401. In various embodiments of the present disclosure, the electronic device 1401 may include at least one of the above-described elements, and may exclude some of the elements or further include other additional elements. Further, some of the elements of the electronic device 1401 according to various embodiments may be combined into one entity, so that the functions of the corresponding elements may be performed in the same way as those before they are combined.

The apparatuses and methods of the disclosure can be implemented in hardware, and in part as firmware or as machine executable computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc., that may store or receive machine executable code or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry that is configured for operation. Under the broadest reasonable interpretation, the appended claims constitute statutory subject matter in compliance with 35 U.S.C. §101 and none of the elements are software per se.

The definition of the terms “unit” or “module” as referred to herein are to be understood as constituting hardware circuitry such as a CCD, CMOS, SoC, AISC, FPGA, a processor or microprocessor (a controller) configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se. In addition, the controllers shown herein are hardware that are comprised of components, for example, a processor or microprocessor configured for operation by the algorithms shown in the flowcharts and described herein.

The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

It will be appreciated that the exemplary embodiments of the present disclosure may be implemented in a form of hardware, machine executable code, or a combination of hardware and machine executable code, that can be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It is appreciated that the storage unit included in the electronic device is one example of the machine-readable storage comprising a non-transitory memory suitable for storing a program or programs including commands for implementing various embodiments of the present disclosure. Accordingly, the present disclosure includes a program that includes a code for implementing an apparatus or a method defined in any claim in the present specification and a machine-readable storage medium that stores such a program. Further, the program may be electronically transferred by a predetermined medium such as a communication signal transferred through a wired or wireless connection, and the present disclosure appropriately includes equivalents of the program.

Further, the electronic device can receive the program from a program providing apparatus connected to the device wirelessly or through a wire and store the received program. The program providing unit may include a program including instructions for performing an authentication method using biometric information, a memory for storing information necessary for the authentication method using the biometric information, a communication unit for performing a wired or wireless communication with the electronic device, and a controller for transmitting a corresponding program to the electronic device upon a request of the electronic device or automatically.

Although specific embodiments are described in the above description of the present disclosure, various modifications can be made without departing from the scope of the present disclosure. Accordingly, the scope of the present disclosure shall not be determined by the above-described embodiments, and is to be determined by the following claims and their equivalents.

What is claimed is:

1. An authentication method using biometric information in an electronic device, the authentication method comprising:
receiving, by the electronic device, biometric information output from an external electronic device;
performing by the electronic device an authentication for the received biometric information by comparing the received biometric information output with biometric information stored in the electronic device; and
transmitting by the electronic device an authentication result to the external electronic device such that the external electronic device performs a predesignated operation.

2. The authentication method of claim 1, wherein the biometric information comprises one or more of iris information, fingerprint information, voice information, and pulse information.

3. The authentication method of claim 1, wherein the biometric information is received from the external electronic device using a short range wireless communication scheme.

4. The authentication method of claim 1, wherein the biometric information is received by the electronic device in a form of raw data.

5. The authentication method of claim 1, wherein the biometric information is received by the electronic device in a processed form using any one of coding or encryption.

6. The authentication method of claim 1, wherein when the external electronic device is a Point Of Sales (POS) device that requests a payment, the authentication result comprises at least one of payment information or security information.

7. The authentication method of claim 1, wherein when the external electronic device comprises a wearable device that interworks with the electronic device for authentication, wherein the authentication result comprises an instruction of controlling an operation of the wearable device, the instruction comprising at least one of an unlocking instruction and an application execution instruction.

8. The authentication method of claim 1, wherein the receiving of the biometric information by the electronic device comprises receiving identification information of the external electronic device together with the biometric information.

9. The authentication method of claim 8, wherein the transmitting of the authentication result by the electronic device comprises, after performing the authentication for the received biometric information, transmitting the authentication result to the external electronic device according to the identification information of the external electronic device sent with the biometric information.

10. The authentication method of claim 1, wherein the transmitting of the authentication result to the external electronic device comprises:
determining when the authentication is performed whether a user of the external electronic device and a user of the electronic device are the same; and
when it is determined the user of the external electronic device and the user of the electronic device are the same, transmitting the authentication result to the external electronic device such that the external electronic device performs the predesignated operation.

11. The authentication method of claim 10, wherein the determining of whether the user of the external electronic device and the user of the electronic device are the same comprises by comparing at least one of biometric information other than the biometric information, account information, or sensor information.

12. An electronic device for performing an authentication method using biometric information, the electronic device comprising:
a communication interface that receives from an external electronic device biometric information of a user collected by the external electronic device;
a non-transitory memory that has previously-stored biometric information about the user; and
a controller that performs an authentication on the biometric information collected by the external electronic device by a comparison with the previously-stored biometric information, and controls the communication interface to transmit an authentication result to the external electronic device such that the external electronic device performs a predesignated operation.

13. The electronic device of claim 12, wherein the biometric information that has an authentication performed thereon comprises one of iris information, fingerprint information, voice information, and pulse information.

14. The electronic device of claim 12, wherein the biometric information is received from the external electronic device in a processed form using any one of coding or encryption.

15. The electronic device of claim 12, wherein when the external electronic device comprises a Point Of Service (POS) device that requests a payment, the authentication result comprises at least one of payment information and security information.

16. The electronic device of claim 12, wherein when the external electronic device comprises a wearable device that interworks with the electronic device, the authentication result comprises an instruction of controlling an operation of the wearable device, the instruction comprising at least one of an unlocking instruction and an application execution instruction.

17. The electronic device of claim 12, wherein the communication interface receives identification information of the external electronic device together with the biometric information.

18. The electronic device of claim 17, wherein the controller, after performing the authentication for the biometric information collected by the external electronic device, transmits the authentication result to the external electronic device using the identification information of the external electronic device.

19. The electronic device of claim 12, wherein the controller, after determining whether a user of the external electronic device and a user of the electronic device are the same when the authentication is performed, controls the communication interface such that the electronic device transmits the authentication result to the external electronic device when the users are the same.

20. The electronic device of claim 19, wherein the controller determines whether the users are the same using at least one of biometric information other than the biometric information, account information, or sensor information.
